(19) United States
(12) Patent Application Publication
(10) Pub. No.: US 2026/0264424 A1
(43) Pub. Date: Sep. 10, 2026

(54) PRINTING APPARATUS

(71) Applicant: SEIKO EPSON CORPORATION, TOKYO (JP)

(72) Inventor: Yuta INOUE, SHIOJIRI-SHI (JP)

(21) Appl. No.: 19/557,304

(22) Filed: Mar. 5, 2026

(30) Foreign Application Priority Data
Mar. 5, 2025 (JP) 2025-034365

(51) Int. Cl. B41J 13/00; B41J 3/60; B41J 11/00

(52) U.S. Cl. CPC B41J 13/0045; B41J 3/60; B41J 11/007

(57) ABSTRACT

A controller executes a first printing of performing printing on a first side of a first medium, a first flipping, a second printing of performing printing on a second side of the first medium, a third printing of performing printing on a first side of a second medium, a second flipping, and a fourth printing of performing printing on a second side of the second medium. The controller executes the first printing, the third printing, the second printing, and the fourth printing in this order. The start timing of the second flipping is posterior to the end timing of the first printing and is anterior to the start timing of the second printing. The interval between the start timing of the third printing and the fourth printing is shorter than the interval between the start timing of the first printing and the second printing.

The present application is based on, and claims priority from JP Application Serial Number 2025-034365, filed Mar. 5, 2025, the disclosure of which is hereby incorporated by reference herein in its entirety.

### BACKGROUND

### 1. Technical Field

The present disclosure relates to a printing apparatus.

### 2. Related Art

A printing apparatus that performs printing on both sides of a medium conveyed along a conveyance path and a flipping path is disclosed in, for example, JP-A-2011-158504. In such a printing apparatus, when printing is performed on both sides of a plurality of media, printing is alternately performed on a first side of the medium and a second side of the medium with respect to the plurality of media based on the same control pattern.

JP-A-2011-158504 is an example of the related art.

However, in such a printing apparatus, a processing interval between consecutive media may be elongated in some cases. By further improving the throughput in such a manner, it is desired to improve the convenience of the user.

### SUMMARY

A printing apparatus configured to solve the problems described above includes: a conveyance unit configured to convey a medium along a conveyance path; a printing unit configured to perform printing on the medium conveyed by the conveyance unit; and a controller configured to control the conveyance unit and the printing unit, wherein the conveyance unit flips the medium by conveying the medium along a flipping path coupled to the conveyance path, the controller is configured to cause: the conveyance unit and the printing unit to execute a first printing operation of performing printing on a first side of a first medium identical to the medium; the conveyance unit to execute a first flipping operation of flipping the first medium having the first side on which the printing was performed by the first printing operation; the conveyance unit and the printing unit to execute a second printing operation of performing printing on a second side of the first medium flipped by the first flipping operation; the conveyance unit and the printing unit to execute a third printing operation of performing printing on a first side of a second medium identical to the medium conveyed subsequently to the first medium; the conveyance unit to execute a second flipping operation of flipping the second medium having the first side on which the printing was performed by the third printing operation; and the conveyance unit and the printing unit to execute a fourth printing operation of performing printing on a second side of the second medium flipped by the second flipping operation so that the first printing operation, the third printing operation, the second printing operation, and the fourth printing operation are executed in this order, a start timing of the second flipping operation is posterior to an end timing of the first printing operation and anterior to a start timing of the second printing operation, and an interval between a start timing of the third printing operation and a start timing of the fourth printing operation is shorter than an interval between a start timing of the first printing operation and the start timing of the second printing operation.

### BRIEF DESCRIPTION OF THE DRAWINGS

FIG. 1 is a schematic diagram illustrating a printing apparatus of a first embodiment.

FIG. 2 is a block diagram illustrating an electrical configuration of the printing apparatus of the first embodiment.

FIG. 3 is a schematic diagram illustrating the printing apparatus of the first embodiment.

FIG. 4 is a schematic diagram illustrating the printing apparatus of the first embodiment.

FIG. 5 is a schematic diagram illustrating the printing apparatus of the first embodiment.

FIG. 6 is a schematic diagram illustrating the printing apparatus of the first embodiment.

FIG. 7 is a schematic diagram illustrating the printing apparatus of the first embodiment.

FIG. 8 is a schematic diagram illustrating the printing apparatus of the first embodiment.

FIG. 9 is a timing chart showing a control pattern in the first embodiment.

FIG. 10 is a timing chart showing a control pattern in a second embodiment.

FIG. 11 is a timing chart showing a control pattern in a third embodiment.

### DESCRIPTION OF EMBODIMENTS

### First Embodiment

An embodiment of a printing apparatus will hereinafter be described with reference to the drawings. In the drawings, assuming that the printing apparatus is placed on a horizontal plane, a direction of gravity is represented by a Z axis, and directions along the horizontal plane are represented by an X axis and a Y axis. The X axis, the Y axis, and the Z axis cross one another.

### Configuration of Printing Apparatus 11

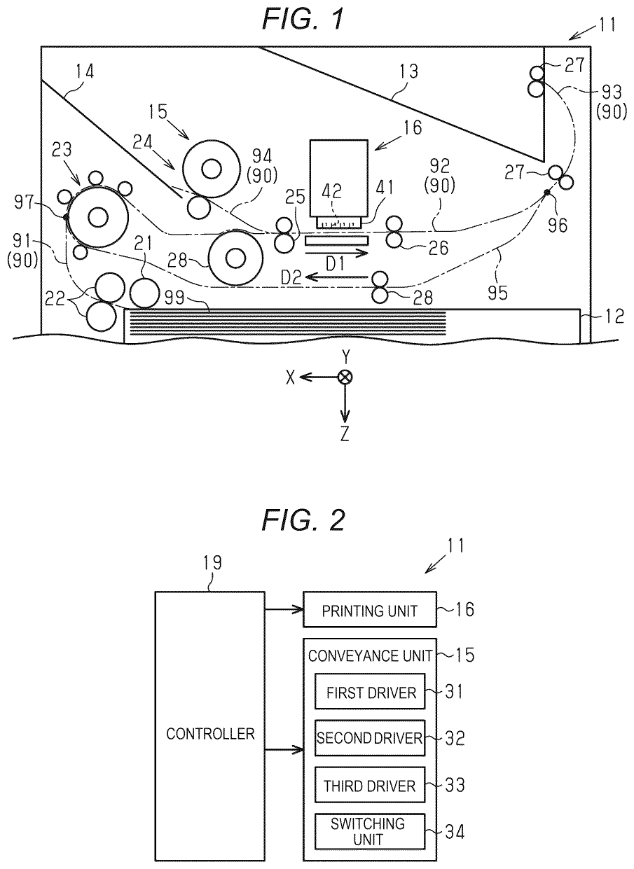

As illustrated in FIG. 1, the printing apparatus 11 is configured to print an image on a medium 99. The printing apparatus 11 is, for example, an inkjet printer that ejects ink as an example of a liquid on the medium 99 to thereby print an image.

The printing apparatus 11 may include one or more medium housing units 12. The medium housing unit 12 can house a plurality of media 99 in a stacked state. The printing apparatus 11 may include a stacker 13. The stacker 13 receives the medium 99 on which printing has been performed. The printing apparatus 11 may include a feed tray 14. The feed tray 14 is a tray capable of stacking the plurality of media 99 separately from the medium housing unit 12.

The printing apparatus 11 includes a conveyance unit 15 and a printing unit 16. The conveyance unit 15 is configured to convey the medium 99 along a conveyance path 90. The conveyance unit 15 is configured to flip the medium 99 by conveying the medium 99 along a flipping path 95.

The printing apparatus 11 includes the conveyance path 90. The conveyance path 90 is a path along which the medium 99 is conveyed. In the drawings, the conveyance path 90 is indicated by a dashed-dotted line. In the present embodiment, a direction in which the medium 99 is conveyed is also referred to as a conveyance direction D1. The conveyance direction D1 is a direction along the conveyance path 90. In the present embodiment, upstream means upstream in the conveyance direction D1, and downstream means downstream in the conveyance direction D1.

The conveyance path 90 includes a first conveyance path 91, a second conveyance path 92, and a third conveyance path 93. The conveyance path 90 may include a fourth conveyance path 94. The first conveyance path 91 is a path located at the most upstream portion in the conveyance path 90. The medium housing unit 12 is disposed at an upstream end of the first conveyance path 91. The first conveyance path 91 is a path for conveying the medium 99 on which printing has not been performed.

The second conveyance path 92 is a path located downstream of the first conveyance path 91 in the conveyance path 90. The second conveyance path 92 is a path for conveying the medium 99 on which the printing unit 16 performs printing.

The third conveyance path 93 is a path located downstream of the second conveyance path 92 in the conveyance path 90. The third conveyance path 93 is a path located at the most downstream portion in the conveyance path 90. The stacker 13 receives the medium 99 discharged from a downstream end of the third conveyance path 93.

The fourth conveyance path 94 is a path that joins the second conveyance path 92 in the conveyance path 90. The feed tray 14 is disposed at an upstream end of the fourth conveyance path 94. The fourth conveyance path 94 is a path for conveying the medium 99 on which printing has not been performed.

The printing apparatus 11 includes the flipping path 95. In the drawings, the flipping path 95 is represented by a dashed-dotted line. The flipping path 95 is a path for flipping the medium 99. The flipping path 95 is coupled to the conveyance path 90.

Specifically, an upstream end of the flipping path 95 is coupled to a branch point 96 of the conveyance path 90. The branch point 96 is disposed in the third conveyance path 93. A downstream end of the flipping path 95 is coupled to a junction 97 of the conveyance path 90. The junction 97 is disposed in the first conveyance path 91.

As described above, the flipping path 95 is a path coupled from the third conveyance path 93 to the first conveyance path 91, but may be a path coupled from the third conveyance path 93 to the second conveyance path 92. Accordingly, the medium 99 is flipped by being conveyed from the third conveyance path 93 to the first conveyance path 91 via the flipping path 95. A direction in which the medium 99 is conveyed in the flipping path 95 is referred to as a flipping direction D2.

The conveyance unit 15 includes a plurality of rollers. The conveyance unit 15 includes a feed roller 21 and a first separation roller pair 22. The feed roller 21 is disposed at a position along the first conveyance path 91. The feed roller 21 is disposed at the most upstream portion of the first conveyance path 91. The feed roller 21 feeds the medium 99 housed in the medium housing unit 12 to the conveyance path 90.

The first separation roller pair 22 is disposed at a position along the first conveyance path 91. The first separation roller pair 22 is disposed downstream of the feed roller 21 in the conveyance path 90. The first separation roller pair 22 separates the media 99 fed by the feed roller 21 one by one.

The conveyance unit 15 includes an intermediate roller pair 23. The intermediate roller pair 23 is disposed at a position along the first conveyance path 91. The intermediate roller pair 23 is disposed downstream of the first separation roller pair 22 in the conveyance path 90. The intermediate roller pair 23 may include a plurality of rollers.

The conveyance unit 15 includes a second separation roller pair 24. The second separation roller pair 24 is disposed at a position along the fourth conveyance path 94. The second separation roller pair 24 is disposed at the most upstream portion of the fourth conveyance path 94. The second separation roller pair 24 is configured to feed the media 99 loaded on the feed tray 14 one by one to the conveyance path 90.

The conveyance unit 15 includes a conveyance roller pair 25, a first discharge roller pair 26, and a second discharge roller pair 27. The conveyance roller pair 25 is disposed at a position along the second conveyance path 92. The conveyance roller pair 25 is disposed downstream of the intermediate roller pair 23 in the conveyance path 90. The conveyance roller pair 25 is disposed downstream of the second separation roller pair 24 in the conveyance path 90. The conveyance roller pair 25 is disposed upstream of the printing unit 16 in the conveyance path 90.

The first discharge roller pair 26 is disposed at a position along the second conveyance path 92. The first discharge roller pair 26 is disposed downstream of the conveyance roller pair 25 in the conveyance path 90. The first discharge roller pair 26 is disposed downstream of the printing unit 16 in the conveyance path 90. The first discharge roller pair 26 is disposed upstream of the branch point 96 between the conveyance path 90 and the flipping path 95.

The second discharge roller pair 27 is disposed at a position along the third conveyance path 93. The second discharge roller pair 27 is disposed downstream of the first discharge roller pair 26 in the conveyance path 90. The second discharge roller pair 27 is disposed downstream of the branch point 96.

The conveyance unit 15 includes a flipping roller pair 28. The flipping roller pair 28 is disposed at a position along the flipping path 95. The flipping roller pair 28 is disposed downstream of the branch point 96 in the flipping path 95. The flipping roller pair 28 is disposed upstream of the junction 97 in the flipping path 95.

The printing unit 16 is configured to perform printing on the medium 99 conveyed by the conveyance unit 15. The printing unit 16 is disposed at a position along the conveyance path 90. Specifically, the printing unit 16 is disposed at a position along the second conveyance path 92.

The printing unit 16 may include an ejection unit 41 that ejects a liquid onto the medium 99. The ejection unit 41 may include a plurality of nozzles 42 that eject the liquid. The printing unit 16 may perform printing by ejecting the liquid.

The ejection unit 41 is a line head, but may be a serial head. The line head is a head that extends in the Y-axis direction and is capable of simultaneously ejecting the liquid onto the entire medium 99 in the Y-axis direction. The serial head is a head capable of ejecting the liquid onto the medium 99 while moving in the Y-axis direction. As described above, the printing unit 16 is configured to extend along the Y-axis direction crossing the conveyance direction D1, but is not limited thereto. The Y-axis direction corresponds to an example of a width direction. In the printing unit 16, the conveyance direction D1 is along the X-axis direction.

### Electrical Configuration of Printing Apparatus 11

As illustrated in FIG. 2, the printing apparatus 11 includes a controller 19. The controller 19 comprehensively controls the printing apparatus 11. Specifically, the controller 19 controls the conveyance unit 15. The controller 19 controls the printing unit 16.

The controller 19 controls various operations executed in the printing apparatus 11. The controller 19 can be configured as a circuit including (α) one or more processors that execute various kinds of processing in accordance with a computer program, (β) one or more dedicated hardware circuits that execute at least some of the various kinds of processing, or (γ) a combination of (α) and (β). The hardware circuit is, for example, an application specific integrated circuit. The processor includes a CPU and a memory such as a RAM and a ROM, and the memory stores program codes or commands configured to cause the CPU to execute the processing. The memory, that is, a computer-readable medium includes any readable medium that can be accessed by a general-purpose or dedicated computer.

The conveyance unit 15 includes a first driver 31. The first driver 31 may be a motor. The first driver 31 is driven based on a drive signal from the controller 19. The first driver 31 conveys the medium 99 along the first conveyance path 91. The first driver 31 is a driving source that rotates the feed roller 21, the first separation roller pair 22, and the intermediate roller pair 23 to thereby convey the media 99 loaded on the medium housing unit 12 one by one along the first conveyance path 91.

The first driver 31 conveys the medium 99 along the fourth conveyance path 94. The first driver 31 is a driving source that rotates the second separation roller pair 24 to convey the media 99 loaded on the feed tray 14 one by one along the fourth conveyance path 94.

The conveyance unit 15 includes a second driver 32. The second driver 32 may be a motor. The second driver 32 is driven based on a drive signal from the controller 19. The second driver 32 conveys the medium 99 along the second conveyance path 92. The second driver 32 is a driving source that rotates the conveyance roller pair 25 and the first discharge roller pair 26 to thereby convey the medium 99 along the second conveyance path 92.

The conveyance unit 15 includes a third driver 33. The third driver 33 may be a motor. The third driver 33 is driven based on a drive signal from the controller 19. The third driver 33 conveys the medium 99 along the third conveyance path 93. The third driver 33 is a driving source that rotates the second discharge roller pair 27 to thereby convey the medium 99 along the third conveyance path 93.

The third driver 33 conveys the medium 99 along the flipping path 95. The third driver 33 is a driving source that rotates the flipping roller pair 28 to thereby convey the medium 99 along the flipping path 95.

The conveyance unit 15 includes a switching unit 34. The switching unit 34 is configured to switch between forward rotation and reverse rotation of the second discharge roller pair 27. That is, the switching unit 34 switches between the conveyance of the medium 99 toward the stacker 13 along the third conveyance path 93 and the conveyance of the medium 99 from the third conveyance path 93 to the flipping path 95. The switching unit 34 may include a clutch. The switching unit 34 switches the rotational direction of the second discharge roller pair 27 based on a control signal from the controller 19. The switching unit 34 is not required to switch the rotational direction of the flipping roller pair 28.

The controller 19 controls the third driver 33 and the switching unit 34 to rotate the second discharge roller pair 27 in a normal direction. Accordingly, the medium 99 is conveyed in the conveyance direction D1 along the third conveyance path 93.

The controller 19 controls the third driver 33 and the switching unit 34 to rotate the second discharge roller pair 27 in a reverse direction. Accordingly, the medium 99 is conveyed along an opposite direction to the conveyance direction D1 in the third conveyance path 93. The medium 99 is conveyed from the third conveyance path 93 to the flipping path 95 at the branch point 96.

The controller 19 controls the third driver 33 to rotate the flipping roller pair 28 in a normal direction. Accordingly, the medium 99 is conveyed along the flipping direction D2 in the flipping path 95 due to the rotation of the flipping roller pair 28.

The printing apparatus 11 may include a display unit (not illustrated). The display unit is configured to display information. The printing apparatus 11 may include an input section (not illustrated). The input section can input an instruction by a user. The input section may be an operation unit that can be operated by the user. The input section may be a communication unit capable of inputting data from a terminal apparatus capable of communicating with the printing apparatus 11.

### Double-Sided Printing On Medium 99

In the present embodiment, the printing apparatus 11 is capable of performing double-sided printing on the medium 99 based on an instruction by the user. The printing apparatus 11 performs printing on an obverse side of the medium 99 after performing printing on a reverse side of the medium 99, but may perform printing on the reverse side of the medium 99 after performing printing on the obverse side of the medium 99. The reverse side of the medium 99 corresponds to an example of a first side. The obverse side of the medium 99 corresponds to an example of a second side.

When performing the double-sided printing on the medium 99, the controller 19 performs control related to conveyance of the medium 99 and printing on the medium 99 based on any of a plurality of control patterns for the double-sided printing. The control pattern is a pattern related to control of the conveyance unit 15 and the printing unit 16. The plurality of control patterns is stored in the memory. The plurality of control patterns is referred to by the controller 19.

Specifically, the controller 19 performs the control related to conveyance of the medium 99 and printing on the medium 99 based on either of a first control pattern and a second control pattern. The first control pattern is a control pattern intended for odd-numbered media 99. The second control pattern is a control pattern intended for even-numbered media 99. The controller 19 repeats an operation based on the first control pattern and an operation based on the second control pattern to thereby perform the double-sided printing on the plurality of media 99.

The controller 19 performs control to perform printing on the reverse side of a first sheet of the media 99 based on the first control pattern and then perform printing on the reverse side of a second sheet of the media 99 based on the second control pattern. Subsequently, the controller 19 performs control to perform printing on the obverse side of the first sheet of the media 99 based on the first control pattern and then perform printing on the obverse side of the second sheet of the media 99 based on the second control pattern. Subsequently, the controller 19 performs printing on the reverse side of a third sheet of the media 99 based on the first control pattern.

### Specific Example of Double-sided Printing

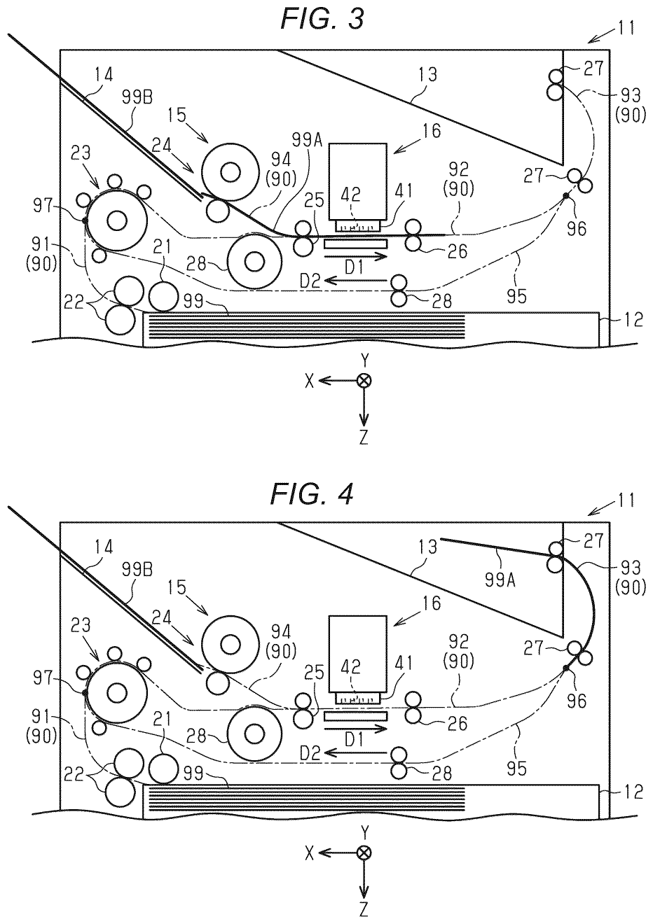

Here, a specific example of performing the double-sided printing on the medium 99 loaded on the feed tray 14 will be described with reference to FIGS. 3 to 8. The first sheet of the media 99 is referred to as a first medium 99A, and the second sheet of the media 99 is referred to as a second medium 99B.

As illustrated in FIG. 3, the first medium 99A loaded on the feed tray 14 is conveyed along the fourth conveyance path 94, and is then conveyed to the second conveyance path 92. Accordingly, printing is performed on the reverse side of the first medium 99A. The second medium 99B is loaded on the feed tray 14.

As illustrated in FIG. 4, the first medium 99A having the reverse side on which printing has been performed is conveyed along the second conveyance path 92 and the third conveyance path 93. The first medium 99A may be conveyed to a position where the leading end of the first medium 99A protrudes from the third conveyance path 93.

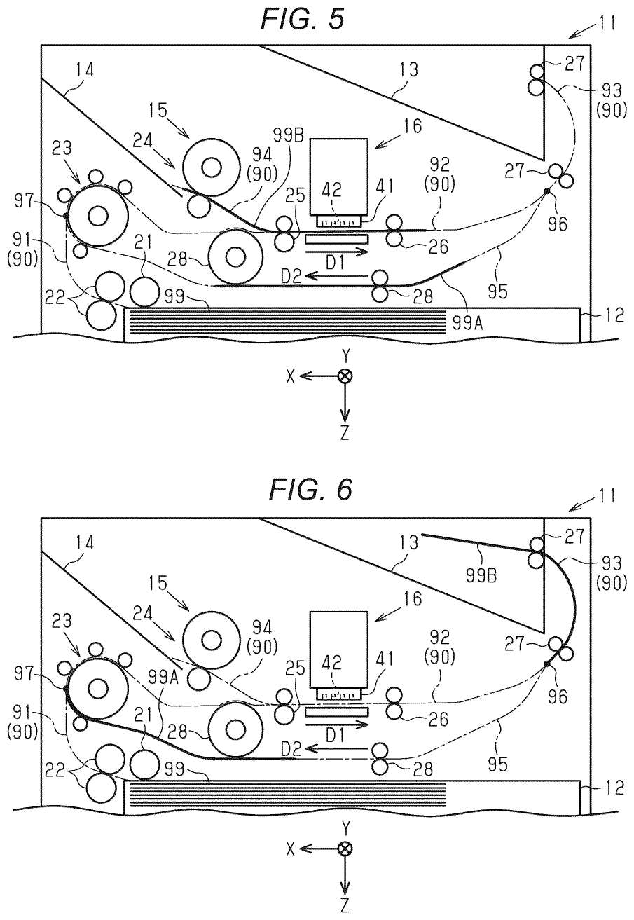

As illustrated in FIG. 5, subsequently, the first medium 99A is conveyed in an opposite direction to the conveyance direction D1 along the third conveyance path 93. The first medium 99A stops in the flipping path 95 after being conveyed from the third conveyance path 93 to the flipping path 95.

The second medium 99B loaded on the feed tray 14 is conveyed along the fourth conveyance path 94, and is then conveyed to the second conveyance path 92. Accordingly, printing is performed on the reverse side of the second medium 99B.

As illustrated in FIG. 6, the second medium 99B having the reverse side on which printing has been performed is conveyed along the second conveyance path 92 and the third conveyance path 93. The second medium 99B may be conveyed to a position where the leading end of the second medium 99B protrudes from the third conveyance path 93.

While the second medium 99B is conveyed in the conveyance direction D1 along the third conveyance path 93, the first medium 99A is conveyed in the flipping direction D2 along the flipping path 95. Accordingly, the first medium 99A is conveyed from the flipping path 95 to the first conveyance path 91.

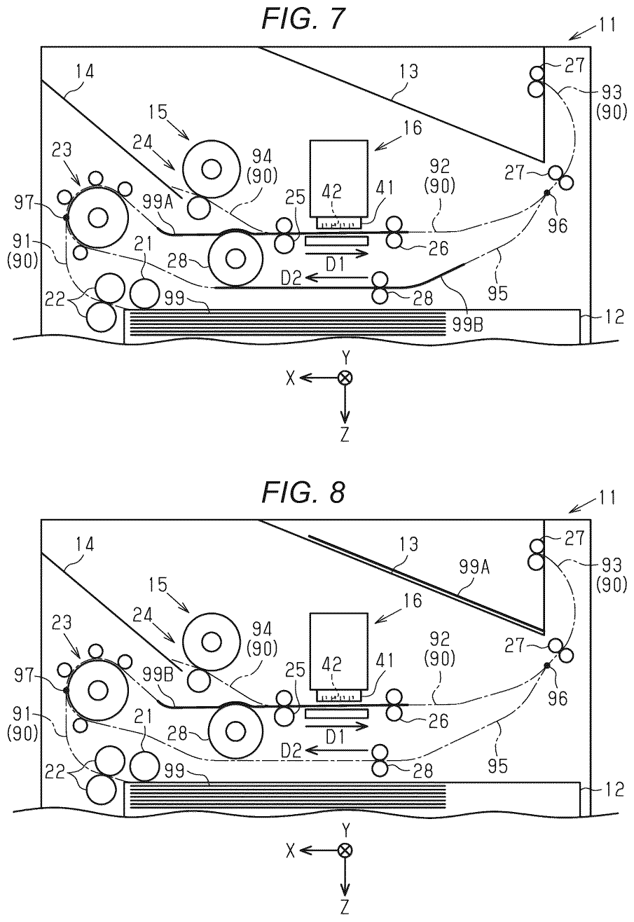

As illustrated in FIG. 7, subsequently, the second medium 99B is conveyed along the third conveyance path 93 in the opposite direction to the conveyance direction D1. The second medium 99B stops in the flipping path 95 after being conveyed from the third conveyance path 93 to the flipping path 95. The first medium 99A is conveyed along the first conveyance path 91 and is then conveyed to the second conveyance path 92. Accordingly, printing is performed on the obverse side of the first medium 99A thus flipped.

As illustrated in FIG. 8, the first medium 99A on which the double-sided printing has been performed is conveyed along the second conveyance path 92 and the third conveyance path 93. Subsequently, the first medium 99A is discharged from the third conveyance path 93 to the stacker 13.

While the first medium 99A is conveyed in the conveyance direction D1 along the third conveyance path 93, the second medium 99B is conveyed in the flipping direction D2 along the flipping path 95. Accordingly, the second medium 99B is conveyed from the flipping path 95 to the first conveyance path 91.

The second medium 99B is conveyed along the first conveyance path 91, and is then conveyed to the second conveyance path 92. Accordingly, printing is performed on the obverse side of the second medium 99B thus flipped. The second medium 99B on which the double-sided printing has been performed is conveyed along the second conveyance path 92 and the third conveyance path 93. Subsequently, the second medium 99B is discharged from the third conveyance path 93 to the stacker 13.

### Operation Content

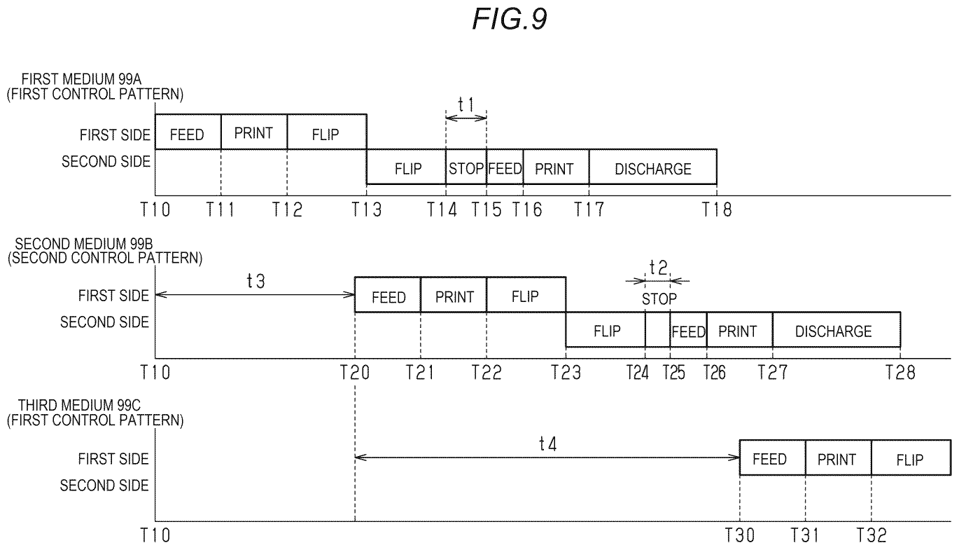

Then, the operation content controlled by the controller 19 in a specific example of performing the double-sided printing on the medium 99 loaded on the feed tray 14 will be described with reference to FIG. 9. The third sheet of the media 99 is referred to as a third medium 99C.

As illustrated in FIG. 9, the controller 19 performs control to perform, based on the first control pattern, an operation corresponding to the first medium 99A. Specifically, the controller 19 causes the conveyance unit 15 and the printing unit 16 to sequentially execute, based on the first control pattern, a first feeding operation, a first printing operation, a first flipping operation, a second feeding operation, a second printing operation, and a first discharging operation. In the drawing, each of the feeding operations, each of the printing operations, each of the flipping operations, and each of the discharging operations are simply referred to as FEED, PRINT, FLIP, and DISCHARGE, respectively.

The first feeding operation is an operation of conveying the first medium 99A loaded on the feed tray 14 along the fourth conveyance path 94. The first feeding operation is an operation performed by the conveyance unit 15. Specifically, the first feeding operation is an operation performed by the first driver 31.

The first printing operation is an operation of conveying the first medium 99A along the second conveyance path 92 and performing printing on the first side of the first medium 99A. The first printing operation is an operation performed by the conveyance unit 15 and the printing unit 16. Specifically, the first printing operation is an operation performed by the second driver 32 and the printing unit 16.

The first flipping operation is an operation of flipping the first medium 99A having the first side on which printing has been performed by the first printing operation. The first flipping operation is an operation of conveying the first medium 99A along the third conveyance path 93 in the conveyance direction D1, then conveying the first medium 99A along the third conveyance path 93 in the opposite direction to the conveyance direction D1, and then conveying the first medium 99A along the flipping path 95. The first flipping operation is an operation performed by the conveyance unit 15. Specifically, the first flipping operation is an operation performed by the third driver 33.

The second feeding operation is an operation of conveying the first medium 99A flipped by the first flipping operation from the flipping path 95 to the first conveyance path 91 and then conveying the first medium 99A along the first conveyance path 91. The second feeding operation is an operation performed by the conveyance unit 15. Specifically, the second feeding operation is an operation performed by the first driver 31 and the third driver 33. The second feeding operation is performed after the conveyance of the first medium 99A is stopped over a first stop time t1 from the end of the first flipping operation.

The second printing operation is an operation of conveying the first medium 99A flipped by the first flipping operation along the second conveyance path 92 and performing printing on the second side of the first medium 99A. The second printing operation is an operation performed by the conveyance unit 15 and the printing unit 16. Specifically, the second printing operation is an operation performed by the second driver 32 and the printing unit 16.

The first discharge operation is an operation of discharging the first medium 99A having the second side on which printing has been performed by the second printing operation. The first discharge operation is an operation of conveying the first medium 99A in the conveyance direction D1 along the third conveyance path 93. The first discharge operation is an operation performed by the conveyance unit 15. Specifically, the first discharge operation is an operation performed by the third driver 33.

The controller 19 performs control to perform, based on the second control pattern, an operation corresponding to the second medium 99B. Specifically, the controller 19 causes the conveyance unit 15 and the printing unit 16 to sequentially execute, based on the second control pattern, a third feeding operation, a third printing operation, a second flipping operation, a fourth feeding operation, a fourth printing operation, and a second discharging operation. The controller 19 performs control based on the second control pattern in parallel to the control based on the first control pattern.

The third feeding operation is an operation of conveying the second medium 99B loaded on the feed tray 14 along the fourth conveyance path 94. The third feeding operation is an operation performed by the conveyance unit 15. Specifically, the third feeding operation is an operation performed by the first driver 31. The third feeding operation may be the same operation as the first feeding operation.

The third printing operation is an operation of conveying the second medium 99B along the second conveyance path 92 and performing printing on the first side of the second medium 99B. The third printing operation is an operation performed by the conveyance unit 15 and the printing unit 16. Specifically, the third printing operation is an operation performed by the second driver 32 and the printing unit 16. The third printing operation may be the same operation as the first printing operation.

The second flipping operation is an operation of flipping the second medium 99B having the first side on which printing has been performed by the third printing operation. The second flipping operation is an operation of conveying the second medium 99B along the third conveyance path 93 in the conveyance direction D1, then conveying the second medium 99B along the third conveyance path 93 in the opposite direction to the conveyance direction D1, and then conveying the second medium 99B along the flipping path 95. The second flipping operation is an operation performed by the conveyance unit 15. Specifically, the second flipping operation is an operation performed by the third driver 33. The second flipping operation may be the same operation as the first flipping operation.

The fourth feeding operation is an operation of conveying the second medium 99B flipped by the second flipping operation from the flipping path 95 to the first conveyance path 91 and then conveying the second medium 99B along the first conveyance path 91. The fourth feeding operation is an operation performed by the conveyance unit 15. Specifically, the fourth feeding operation is an operation performed by the first driver 31 and the third driver 33. The fourth feeding operation may be the same operation as the second feeding operation. The fourth feeding operation is performed after the conveyance of the second medium 99B is stopped over a second stop time t2 from the end of the second flipping operation. The second stop time t2 is shorter than the first stop time t1.

The fourth printing operation is an operation of conveying the second medium 99B flipped by the second flipping operation along the second conveyance path 92 and performing printing on the second side of the second medium 99B. The fourth printing operation is an operation performed by the conveyance unit 15 and the printing unit 16. Specifically, the fourth printing operation is an operation performed by the second driver 32 and the printing unit 16. The fourth printing operation may be the same operation as the second printing operation.

The second discharge operation is an operation of discharging the second medium 99B having the second side on which printing has been performed by the fourth printing operation. The second discharge operation is an operation of conveying the second medium 99B in the conveyance direction D1 along the third conveyance path 93. The second discharge operation is an operation performed by the conveyance unit 15. Specifically, the second discharge operation is an operation performed by the third driver 33. The second discharge operation may be the same operation as the first discharge operation.

The controller 19 repeats starting the control based on the second control pattern after starting the control based on the first control pattern. Therefore, the controller 19 performs control to perform, based on the first control pattern, an operation corresponding to the third medium 99C in the same manner as the operation corresponding to the first medium 99A.

### Operation Timings

Then, operation timings controlled by the controller 19 will be described.

At a timing indicated by a reference symbol T10, the controller 19 controls the first driver 31 to execute the first feeding operation based on the first control pattern. At a timing indicated by a reference symbol T11, the controller 19 controls the second driver 32 and the printing unit 16 to execute the first printing operation. Accordingly, printing is performed on the first side of the first medium 99A.

At a timing indicated by a reference symbol T12, the controller 19 controls the third driver 33 to execute the first flipping operation. Specifically, at the timing indicated by the reference symbol T12, the controller 19 controls the third driver 33 to convey the first medium 99A in the conveyance direction D1 along the third conveyance path 93.

Subsequently, at a timing indicated by a reference symbol T13, the controller 19 controls the third driver 33 and the switching unit 34 to convey the first medium 99A along the third conveyance path 93 in the opposite direction to the conveyance direction D1. The controller 19 controls the third driver 33 and the switching unit 34 to convey the first medium 99A in the flipping direction D2 along the flipping path 95.

At a timing indicated by a reference symbol T14, the controller 19 controls the third driver 33 to stop the conveyance of the first medium 99A over the first stop time t1. That is, the controller 19 stops the conveyance of the first medium 99A for the first stop time t1 between the first flipping operation and the second printing operation.

At a timing indicated by a reference symbol T15, the controller 19 controls the first driver 31 and the third driver 33 to execute the second feeding operation. At a timing indicated by a reference symbol T16, the controller 19 controls the second driver 32 and the printing unit 16 to execute the second printing operation. Accordingly, printing is performed on the second side of the first medium 99A.

At a timing indicated by a reference symbol T17, the controller 19 controls the third driver 33 to execute the first discharge operation. Accordingly, at a timing indicated by a reference symbol T18, the first medium 99A on which the double-sided printing has been performed is discharged to the stacker 13.

When a third time t3 elapses from the timing indicated by the reference symbol T10, the controller 19 controls the first driver 31 to execute the third feeding operation based on the second control pattern at a timing indicated by a reference symbol T20. At a timing indicated by a reference symbol T21, the controller 19 controls the second driver 32 and the printing unit 16 to execute the third printing operation. Accordingly, printing is performed on the first side of the second medium 99B.

At a timing indicated by a reference symbol T22, the controller 19 controls the third driver 33 to execute the second flipping operation. Specifically, at the timing indicated by the reference symbol T22, the controller 19 controls the third driver 33 to convey the second medium 99B in the conveyance direction D1 along the third conveyance path 93.

Subsequently, at a timing indicated by a reference symbol T23, the controller 19 controls the third driver 33 and the switching unit 34 to convey the second medium 99B along the third conveyance path 93 in the opposite direction to the conveyance direction D1. The controller 19 controls the third driver 33 and the switching unit 34 to convey the second medium 99B in the flipping direction D2 along the flipping path 95.

At a timing indicated by a reference symbol T24, the controller 19 controls the third driver 33 to stop the conveyance of the second medium 99B in the flipping path 95 over the second stop time t2. That is, the controller 19 stops the conveyance of the second medium 99B for the second stop time t2 between the second flipping operation and the fourth printing operation.

At a timing indicated by a reference symbol T25, the controller 19 controls the first driver 31 and the third driver 33 to execute the fourth feeding operation. At a timing indicated by a reference symbol T26, the controller 19 controls the second driver 32 and the printing unit 16 to execute the fourth printing operation. Accordingly, printing is performed on the second side of the second medium 99B.

At a timing indicated by a reference symbol T27, the controller 19 controls the third driver 33 to execute the second discharge operation. Accordingly, at a timing indicated by a reference symbol T28, the second medium 99B on which the double-sided printing has been performed is discharged to the stacker 13.

When a fourth time t4 elapses from the timing indicated by the reference symbol T20, the controller 19 controls the first driver 31 to execute the feeding operation of feeding the third medium 99C based on the first control pattern at a timing indicated by a reference symbol T30. At a timing indicated by a reference symbol T31, the controller 19 controls the second driver 32 and the printing unit 16 to execute a printing operation. Accordingly, printing is performed on the first side of the third medium 99C. At a timing indicated by a reference symbol T32, the controller 19 controls the third driver 33 to execute a flipping operation of flipping the third medium 99C. The description of subsequent operations for the third medium 99C will be omitted.

In this way, when the operation based on the first control pattern and the operation based on the second control pattern are arranged in chronological order, the controller 19 causes the conveyance unit 15 and the printing unit 16 to execute the first printing operation, the third printing operation, the second printing operation, and the fourth printing operation in this order.

When the operation based on the first control pattern and the operation based on the second control pattern are compared to each other, the start timing of the second flipping operation indicated by the reference symbol T22 is posterior to the end timing of the first printing operation indicated by the reference symbol T12. The start timing of the second flipping operation indicated by the reference symbol T22 is anterior to the start timing of the second printing operation indicated by the reference symbol T16.

In addition thereto, the second stop time t2 is shorter than the first stop time t1. Therefore, the interval between the start timing of the third printing operation indicated by the reference symbol T21 and the start timing of the fourth printing operation indicated by the reference symbol T26 is shorter than the interval between the start timing of the first printing operation indicated by the reference symbol T11 and the start timing of the second printing operation indicated by the reference symbol T16.

As described above, the second control pattern is a control pattern in which the interval between the start timings of the printing operations by the conveyance unit 15 and the printing unit 16 is shorter than that of the first control pattern. The controller 19 does not execute the flipping operation of the third medium 99C conveyed subsequent to the second medium 99B between the third printing operation and the fourth printing operation.

### Functions and Advantages of First Embodiment

Functions and advantages of the first embodiment will be described.

(1-1) The controller 19 executes the first printing operation, the third printing operation, the second printing operation, and the fourth printing operation in this order. The start timing of the second flipping operation is posterior to the end timing of the first printing operation and is anterior to the start timing of the second printing operation. The interval between the start timing of the third printing operation and the start timing of the fourth printing operation is shorter than the interval between the start timing of the first printing operation and the start timing of the second printing operation. According to this configuration, it is possible to hasten the fourth printing operation on the second medium 99B. Accordingly, the throughput can be further improved. Therefore, the convenience of the user can be improved.

(1-2) The controller 19 does not execute the flipping operation of the third medium 99C conveyed subsequent to the second medium 99B between the third printing operation and the fourth printing operation. According to this configuration, the interval between the start timing of the third printing operation and the start timing of the fourth printing operation can be made shorter than the interval between the start timing of the first printing operation and the start timing of the second printing operation. Therefore, it is possible to hasten the fourth printing operation on the second medium 99B. Accordingly, the throughput can be further improved. Therefore, the convenience of the user can be improved.

(1-3) The second stop time t2 for stopping the conveyance of the second medium 99B is shorter than the first stop time t1 for stopping the conveyance of the first medium 99A. According to this configuration, the interval between the start timing of the third printing operation and the start timing of the fourth printing operation can be made shorter than the interval between the start timing of the first printing operation and the start timing of the second printing operation. Therefore, it is possible to hasten the fourth printing operation on the second medium 99B. Accordingly, the throughput can be further improved. Therefore, the convenience of the user can be improved.

(1-4) The second control pattern is a control pattern in which the interval between the start timings of the printing operations by the conveyance unit 15 and the printing unit 16 is shorter than that of the first control pattern. The controller 19 repeats starting the control based on the second control pattern after starting the control based on the first control pattern. According to this configuration, the interval between the start timing of the third printing operation and the start timing of the fourth printing operation can be made shorter than the interval between the start timing of the first printing operation and the start timing of the second printing operation. Therefore, it is possible to hasten the fourth printing operation on the second medium 99B. Accordingly, the throughput can be further improved. Therefore, the convenience of the user can be improved.

(1-5) The conveyance unit 15 includes the first driver 31, the second driver 32, and the third driver 33. According to this configuration, by effectively utilizing the first driver 31, the second driver 32, and the third driver 33, it is possible to convey the medium 99 along the first conveyance path 91 and the fourth conveyance path 94, along the second conveyance path 92, and along the third conveyance path 93 and the flipping path 95. In addition, by sharing the third driver 33, it is possible to convey the medium 99 along both the third conveyance path 93 and the flipping path 95.

### Second Embodiment

Then, a second embodiment will be described. In the following description, redundant descriptions of the same configurations as those of the embodiment having already been described will be omitted or simplified, and configurations different from those of the embodiment having already been described will be described.

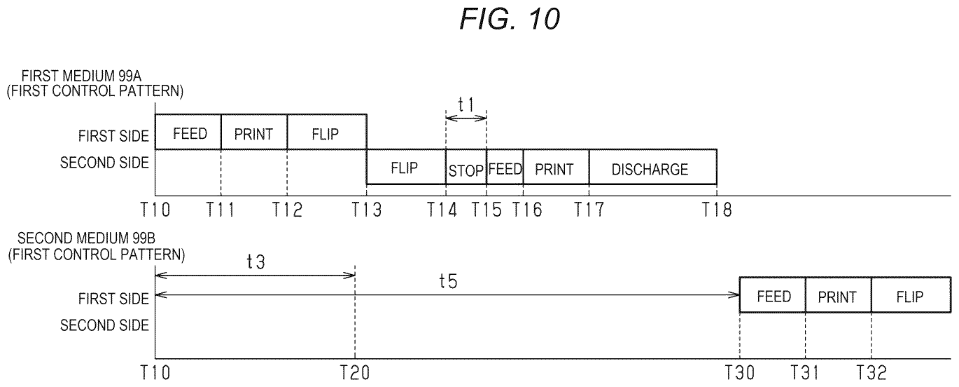

As illustrated in FIG. 10, in the second embodiment, when the conveyance of the second medium 99B is not started even after a predetermined time has elapsed from the timing indicated by the reference symbol T10, the controller 19 may perform the control to perform the operation corresponding to the second medium 99B based on the first control pattern. The predetermined time is longer than the third time t3, but may be the same as the third time t3.

The printing apparatus 11 may include detectors that detect the medium 99 in the first conveyance path 91 and the fourth conveyance path 94. The controller 19 may determine that the conveyance of the second medium 99B is not started based on the detection signals from the detectors. The controller 19 may determine that the conveyance of the second medium 99B is not started by detecting an occurrence of an error. When it is determined that the medium 99 is not loaded on the medium housing unit 12 and the feed tray 14, the controller 19 may determine that the conveyance of the second medium 99B is not started.

When the conveyance of the second medium 99B is not started, the controller 19 may perform control to perform an operation corresponding to the second medium 99B based on the first control pattern after a fifth time t5 has elapsed from the timing indicated by the reference symbol T10. The fifth time t5 may be the total time of the third time t3 and the fourth time t4.

As described above, when the conveyance of the second medium 99B is not started by the conveyance unit 15 after the end of the first printing operation, the controller 19 performs control to perform the operation corresponding to the second medium 99B based on the first control pattern after the conveyance of the first medium 99A is ended. Subsequently, the controller 19 performs control to perform the operation corresponding to the third medium 99C based on the second control pattern.

Accordingly, the control of odd-numbered medium 99 is changed from the control based on the first control pattern to the control based on the second control pattern. The control of the even-numbered medium 99 is changed from the control based on the second control pattern to the control based on the first control pattern.

When the conveyance of the second medium 99B is started before the predetermined time elapses from the timing indicated by the reference symbol T10, the controller 19 performs control to perform the operation corresponding to the second medium 99B based on the second control pattern in the same manner as in the first embodiment.

### Functions and Advantages of Second Embodiment

Functions and advantages of the second embodiment will be described.

(2-1) When the conveyance of the second medium 99B is not started after the end of the first printing operation, the controller 19 performs control to perform the operation corresponding to the second medium 99B based on the first control pattern after the conveyance of the first medium 99A is ended. The controller 19 performs control to perform, based on the second control pattern, the operation corresponding to the third medium 99C. According to this configuration, when the conveyance of the second medium 99B is not started after the end of the first printing operation, the control of the conveyance unit 15 and the printing unit 16 can be performed using the first control pattern and the second control pattern. Therefore, the convenience of the user can be improved.

### Third Embodiment

Then, a third embodiment will be described.

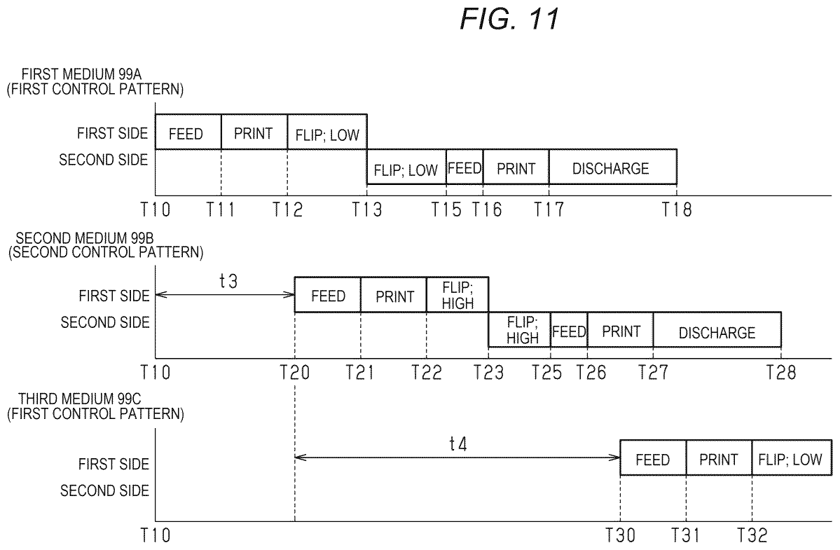

As illustrated in FIG. 11, in the third embodiment, the controller 19 may change the conveyance speed of the medium 99 between the first control pattern and the second control pattern. For example, in the second flipping operation based on the second control pattern, the controller 19 may convey the medium 99 at a conveyance speed faster than that in the first flipping operation based on the first control pattern.

As described above, the conveyance speed of the second medium 99B in the second flipping operation is higher than the conveyance speed of the first medium 99A in the first flipping operation. That is, the conveyance speed of the second medium 99B between the start timing of the third printing operation and the start timing of the fourth printing operation is faster than the conveyance speed of the first medium 99A between the start timing of the first printing operation and the start timing of the second printing operation. Therefore, the interval between the start timing of the third printing operation indicated by the reference symbol T21 and the start timing of the fourth printing operation indicated by the reference symbol T26 is shorter than the interval between the start timing of the first printing operation indicated by the reference symbol T11 and the start timing of the second printing operation indicated by the reference symbol T16.

The controller 19 is not required to stop the conveyance of the first medium 99A between the first flipping operation and the second printing operation. The controller 19 is not required to stop the conveyance of the second medium 99B between the second flipping operation and the fourth printing operation.

### Functions and Advantages of Third Embodiment

Functions and advantages of the third embodiment will be described.

(3-1) The conveyance speed of the second medium 99B between the start timing of the third printing operation and the start timing of the fourth printing operation is faster than the conveyance speed of the first medium 99A between the start timing of the first printing operation and the start timing of the second printing operation. According to this configuration, the interval between the start timing of the third printing operation and the start timing of the fourth printing operation can be made shorter than the interval between the start timing of the first printing operation and the start timing of the second printing operation. Therefore, it is possible to hasten the fourth printing operation on the second medium 99B. Accordingly, the throughput can be further improved. Therefore, the convenience of the user can be improved.

### Modified Examples

The present embodiment can be implemented with the following modifications. The present embodiment and the following modified examples can be implemented in combination with each other as long as no technical inconsistencies are involved.

In the first embodiment and the second embodiment, there may be a period in which the conveyance unit 15 executes the first flipping operation and the second flipping operation in parallel to each other. Even in such a case, the controller 19 can rotate the second discharge roller pair 27 in the normal direction by controlling the switching unit 34 in the second flipping operation while rotating the flipping roller pair 28 in the normal direction in the first flipping operation.

In the first embodiment and the second embodiment, when the medium 99 is stopped after the first flipping operation and the second flipping operation, the medium 99 may be stopped in the first conveyance path 91 instead of the flipping path 95.

In the second embodiment, when the conveyance of the second medium 99B is not started, the controller 19 may perform control to perform the operation corresponding to the second medium 99B based on the first control pattern after a predetermined time elapses from the timing indicated by the reference symbol T10. The predetermined time may be shorter than the fifth time t5 or may be longer than the fifth time t5. When the conveyance of the second medium 99B is not started, the controller 19 may perform control to perform the operation corresponding to the second medium 99B based on the first control pattern when it becomes possible to convey the second medium 99B.

In the third embodiment, the controller 19 may stop the conveyance of the first medium 99A over the first stop time t1 between the first flipping operation and the second printing operation. The controller 19 may stop the conveyance of the second medium 99B over the second stop time t2 between the second flipping operation and the fourth printing operation. In such a case, the second stop time t2 is shorter than the first stop time t1, but may be longer than the first stop time t1 or may be the same as the first stop time t1.

The controller 19 may repeatedly control the conveyance unit 15 and the printing unit 16 based on the first control pattern and the second control pattern with three or more media 99 as one set. Citing a specific example of controlling three sheets of the media 99 as one set, the controller 19 performs control to perform an operation corresponding to the first sheet of the media 99 based on the first control pattern. The controller 19 performs control to perform an operation corresponding to the second sheet of the media 99 based on the first control pattern. The controller 19 performs control to perform an operation corresponding to the third sheet of the media 99 based on the second control pattern. In such a case, the second sheet of the media 99 corresponds to an example of the first medium 99A. The third sheet of the media 99 corresponds to an example of the second medium 99B. A fourth sheet of the media 99 corresponds to an example of the third medium 99C.

As described above, the controller 19 may perform control to perform an operation corresponding to a (multiple of a natural number N)-th sheet out of the media 99 based on the second control pattern. The controller 19 may perform control to perform an operation corresponding to other sheets than the (multiple of the natural number N)-th sheet out of the medium 99 based on the first control pattern.

The controller 19 may control the conveyance unit 15 and the printing unit 16 based on three or more control patterns. The three or more control patterns may include the first control pattern and the second control pattern. The controller 19 may control the conveyance unit 15 and the printing unit 16 not based on the control pattern but based on detection signals from various medium detectors.

The printing apparatus 11 may include a switchback path. The printing apparatus 11 performs a switchback operation of the medium 99 using the third conveyance path 93, but may perform the switchback operation of the medium 99 using the switchback path separately from the third conveyance path 93.

The upstream end of the flipping path 95 may be coupled to the downstream end of the second conveyance path 92. The switchback path may be coupled to the downstream end of the second conveyance path 92 and the upstream end of the flipping path 95. The downstream end of the flipping path 95 may be coupled to the upstream end of the second conveyance path 92. The medium 99 may be conveyed from the second conveyance path 92 to the switchback path, and then conveyed from the switchback path to the flipping path 95. The medium 99 may be conveyed from the flipping path 95 to the second conveyance path 92 in a flipped state.

At least one of the first separation roller pair 22, the intermediate roller pair 23, the second separation roller pair 24, the conveyance roller pair 25, the first discharge roller pair 26, the second discharge roller pair 27, and the flipping roller pair 28 may be configured with a driving roller and a driven roller.

At least one of the first separation roller pair 22, the intermediate roller pair 23, the second separation roller pair 24, the conveyance roller pair 25, the first discharge roller pair 26, the second discharge roller pair 27, and the flipping roller pair 28 may be configured with a driving roller pair.

The first separation roller pair 22, the intermediate roller pair 23, the second separation roller pair 24, the conveyance roller pair 25, the first discharge roller pair 26, the second discharge roller pair 27, and the flipping roller pair 28 may be configured with a single roller pair or a plurality of roller pairs.

The controller 19 may control the conveyance unit 15 and the printing unit 16 when the medium 99 is fed from the medium housing unit 12 in the same manner as when the medium 99 is fed from the feed tray 14. That is, when the feeding source is the same, the controller 19 may control the conveyance unit 15 and the printing unit 16 based on the first control pattern and the second control pattern. The printing apparatus 11 may be configured not to feed the medium 99 from the feed tray 14. The printing apparatus 11 may include at least one of the medium housing unit 12 and the feed tray 14.

The conveyance unit 15 may include another driver than the first driver 31, the second driver 32, and the third driver 33. For example, the conveyance unit 15 may include a fourth driver that rotates the flipping roller pair 28 separately from the third driver 33. In this case, the third driver 33 rotates the second discharge roller pair 27 without rotating the flipping roller pair 28. For example, the conveyance unit 15 may include a fifth driver that rotates the second separation roller pair 24 separately from the first driver 31. In this case, the first driver 31 rotates the feed roller 21, the first separation roller pair 22, and the intermediate roller pair 23 without rotating the second separation roller pair 24.

The conveyance unit 15 may include a second switching unit that switches whether to drive the flipping roller pair 28 separately from the switching unit 34. The controller 19 may selectively control driving of the second discharge roller pair 27 and driving of the flipping roller pair 28 by controlling the second switching unit.

The conveyance unit 15 is not required to include the switching unit 34. In particular, when the driving source of the second discharge roller pair 27 and the driving source of the flipping roller pair 28 are separate, the conveyance unit 15 is not required to include the switching unit 34 as long as the second discharge roller pair 27 can be rotated in a reverse direction.

The conveyance unit 15 is not required to include at least one of the first driver 31, the second driver 32, and the third driver 33. The conveyance unit 15 may share at least one of combinations of the first driver 31, the second driver 32, and the third driver 33.

The medium 99 may be a paper sheet, a resin film or resin sheet, a composite film of resin and metal, a laminated film, a woven fabric, a nonwoven fabric, a metal foil, a metal film, a ceramic sheet, clothing, or the like.

The liquid can appropriately be selected as long as the liquid can adhere to the medium 99 to thereby perform printing on the medium 99. For example, the ink includes what is obtained by dissolving, dispersing, or mixing particles of a functional material configured with solid matters such as pigment or metal particles in a solvent, and includes various compositions such as an aqueous ink, an oil-based ink, a gel ink, and a hot melt ink.

A lateral printer may be adopted as the printing apparatus 11. The lateral printer is a printer in which a carriage is movable in two directions of the X-axis direction and the Y-axis direction. The printing apparatus 11 is not limited to the inkjet printer and may be a dot impact printer. The printing apparatus 11 may be a laser printer.

The expression “at least one of” used in the present specification means one or more of desired options. As an example, when the number of alternatives is two, the expression “at least one of” used in the present specification means just one of the options or both of the two options. As another example, when the number of options is three or more, the expression “at least one of” used in the present specification means just one of the options or a combination of any two or more of the options.

### Appendices

Technical ideas understood from the embodiment and modified examples described above and the functions and advantages thereof will hereinafter be described. The technical ideas, and the functions and advantages thereof can be combined with each other within a range where no technical contradictions are involved.

[1] A printing apparatus includes a conveyance unit configured to convey a medium along a conveyance path; a printing unit configured to perform printing on the medium conveyed by the conveyance unit; and a controller configured to control the conveyance unit and the printing unit, wherein the conveyance unit flips the medium by conveying the medium along a flipping path coupled to the conveyance path, the controller is configured to cause: the conveyance unit and the printing unit to execute a first printing operation of performing printing on a first side of a first medium identical to the medium; the conveyance unit to execute a first flipping operation of flipping the first medium having the first side on which the printing was performed by the first printing operation; the conveyance unit and the printing unit to execute a second printing operation of performing printing on a second side of the first medium flipped by the first flipping operation; the conveyance unit and the printing unit to execute a third printing operation of performing printing on a first side of a second medium identical to the medium conveyed subsequently to the first medium; the conveyance unit to execute a second flipping operation of flipping the second medium having the first side on which the printing was performed by the third printing operation; and the conveyance unit and the printing unit to execute a fourth printing operation of performing printing on a second side of the second medium flipped by the second flipping operation so that the first printing operation, the third printing operation, the second printing operation, and the fourth printing operation are executed in this order, a start timing of the second flipping operation is posterior to an end timing of the first printing operation and anterior to a start timing of the second printing operation, and an interval between a start timing of the third printing operation and a start timing of the fourth printing operation is shorter than an interval between a start timing of the first printing operation and the start timing of the second printing operation.

According to this configuration, the interval between the start timing of the third printing operation and the start timing of the fourth printing operation can be made shorter than the interval between the start timing of the first printing operation and the start timing of the second printing operation. Therefore, it is possible to hasten the fourth printing operation on the second medium. Accordingly, the throughput can be further improved. Therefore, the convenience of the user can be improved.

[2] In the printing apparatus described above, the controller is not required to cause, between the third printing operation and the fourth printing operation, the conveyance unit to execute a flipping operation of the medium conveyed subsequent to the second medium.

According to this configuration, the flipping operation of the medium conveyed subsequently to the second medium is not executed between the third printing operation and the fourth printing operation. As a result, the interval between the start timing of the third printing operation and the start timing of the fourth printing operation can be made shorter than the interval between the start timing of the first printing operation and the start timing of the second printing operation. Therefore, it is possible to hasten the fourth printing operation on the second medium. Accordingly, the throughput can be further improved. Therefore, the convenience of the user can be improved.

[3] In the printing apparatus described above, the controller may be configured to: stop the conveyance of the first medium over a first stop time between the first flipping operation and the second printing operation; and stop the conveyance of the second medium over a second stop time between the second flipping operation and the fourth printing operation, and the second stop time may be shorter than the first stop time.

According to this configuration, the second stop time for stopping the conveyance of the second medium between the second flipping operation and the fourth printing operation can be made shorter than the first stop time for stopping the conveyance of the first medium between the first flipping operation and the second printing operation. As a result, the interval between the start timing of the third printing operation and the start timing of the fourth printing operation can be made shorter than the interval between the start timing of the first printing operation and the start timing of the second printing operation. Therefore, it is possible to hasten the fourth printing operation on the second medium. Accordingly, the throughput can be further improved. Therefore, the convenience of the user can be improved.

[4] In the printing apparatus described above, a conveyance speed of the second medium between the start timing of the third printing operation and the start timing of the fourth printing operation may be faster than a conveyance speed of the first medium between the start timing of the first printing operation and the start timing of the second printing operation.

According to this configuration, the conveyance speed of the second medium between the start timing of the third printing operation and the start timing of the fourth printing operation can be made faster than the conveyance speed of the first medium between the start timing of the first printing operation and the start timing of the second printing operation. As a result, the interval between the start timing of the third printing operation and the start timing of the fourth printing operation can be made shorter than the interval between the start timing of the first printing operation and the start timing of the second printing operation. Therefore, it is possible to hasten the fourth printing operation on the second medium. Accordingly, the throughput can be further improved. Therefore, the convenience of the user can be improved.

[5] In the printing apparatus described above, the controller may be configured to perform: control to perform an operation corresponding to the first medium based on a first control pattern, and control to perform an operation corresponding to the second medium based on a second control pattern, the second control pattern may be shorter than the first control pattern in an interval between the start timings of the printing operations by the conveyance unit and the printing unit, and the controller may repeat starting the control based on the second control pattern after starting the control based on the first control pattern.

According to this configuration, it is repeated to start the control based on the second control pattern that is shorter in the interval between the start timings of the printing operations than the first control pattern after starting the control based on the first control pattern. As a result, the interval between the start timing of the third printing operation and the start timing of the fourth printing operation can be made shorter than the interval between the start timing of the first printing operation and the start timing of the second printing operation. Therefore, it is possible to hasten the fourth printing operation on the second medium. Accordingly, the throughput can be further improved. Therefore, the convenience of the user can be improved.

[6] In the printing apparatus described above, the controller may be configured to perform: control to perform the operation corresponding to the second medium based on the first control pattern after the conveyance of the first medium ends when the conveyance of the second medium is not started by the conveyance unit after the first printing operation ends; and control to perform, based on the second control pattern, an operation corresponding to a third medium identical to the medium conveyed subsequently to the second medium by the conveyance unit.

According to this configuration, when the conveyance of the second medium is not started after the first printing operation ends, it is possible to perform control to perform the operation corresponding to the second medium based on the first control pattern. Subsequently, it is possible to perform control to perform the operation corresponding to the third medium based on the second control pattern. Accordingly, when the conveyance of the second medium is not started after the first printing operation ends, the conveyance unit and the printing unit can be controlled using the first control pattern and the second control pattern. Therefore, the convenience of the user can be improved.

[7] In the printing apparatus described above, the conveyance path may include a first conveyance path, a second conveyance path downstream of the first conveyance path, and a third conveyance path downstream of the second conveyance path, the printing unit may be disposed at a position along the second conveyance path, the flipping path may be a path coupled from the third conveyance path to the first conveyance path or the second conveyance path, and the conveyance unit may include: a first driver configured to convey the medium along the first conveyance path, a second driver configured to convey the medium along the second conveyance path, and a third driver configured to convey the medium along the third conveyance path and the flipping path.

According to this configuration, by using the first driver, the second driver, and the third driver, it is possible to convey the medium along the first conveyance path, the second conveyance path, the third conveyance path, and the flipping path. In addition, by sharing the third driver, it is possible to convey the medium along both the third conveyance path and the flipping path.

What is claimed is:

1. A printing apparatus comprising:
a conveyance unit configured to convey a medium along a conveyance path;
a printing unit configured to perform printing on the medium conveyed by the conveyance unit; and
a controller configured to control the conveyance unit and the printing unit, wherein
the conveyance unit flips the medium by conveying the medium along a flipping path coupled to the conveyance path,
the controller is configured to cause:
the conveyance unit and the printing unit to execute a first printing operation of performing printing on a first side of a first medium identical to the medium;
the conveyance unit to execute a first flipping operation of flipping the first medium having the first side on which the printing was performed by the first printing operation;
the conveyance unit and the printing unit to execute a second printing operation of performing printing on a second side of the first medium flipped by the first flipping operation;
the conveyance unit and the printing unit to execute a third printing operation of performing printing on a first side of a second medium identical to the medium conveyed subsequently to the first medium;
the conveyance unit to execute a second flipping operation of flipping the second medium having the first side on which the printing was performed by the third printing operation; and
the conveyance unit and the printing unit to execute a fourth printing operation of performing printing on a second side of the second medium flipped by the second flipping operation
so that the first printing operation, the third printing operation, the second printing operation, and the fourth printing operation are executed in this order,
a start timing of the second flipping operation is posterior to an end timing of the first printing operation and anterior to a start timing of the second printing operation, and
an interval between a start timing of the third printing operation and a start timing of the fourth printing operation is shorter than an interval between a start timing of the first printing operation and the start timing of the second printing operation.

2. The printing apparatus according to claim 1, wherein
the controller does not cause, between the third printing operation and the fourth printing operation, the conveyance unit to execute a flipping operation of the medium conveyed subsequent to the second medium.

3. The printing apparatus according to claim 1, wherein
the controller is configured to:
stop the conveyance of the first medium over a first stop time between the first flipping operation and the second printing operation; and
stop the conveyance of the second medium over a second stop time between the second flipping operation and the fourth printing operation, and
the second stop time is shorter than the first stop time.

4. The printing apparatus according to claim 1, wherein
a conveyance speed of the second medium between the start timing of the third printing operation and the start timing of the fourth printing operation is faster than a conveyance speed of the first medium between the start timing of the first printing operation and the start timing of the second printing operation.

5. The printing apparatus according to claim 1, wherein
the controller is configured to perform:
control to perform an operation corresponding to the first medium based on a first control pattern, and
control to perform an operation corresponding to the second medium based on a second control pattern,
the second control pattern is shorter than the first control pattern in an interval between the start timings of the printing operations by the conveyance unit and the printing unit, and
the controller repeats starting the control based on the second control pattern after starting the control based on the first control pattern.

6. The printing apparatus according to claim 5, wherein
the controller is configured to perform:
control to perform the operation corresponding to the second medium based on the first control pattern after the conveyance of the first medium ends when the conveyance of the second medium is not started by the conveyance unit after the first printing operation ends; and
control to perform, based on the second control pattern, an operation corresponding to a third medium identical to the medium conveyed subsequently to the second medium by the conveyance unit.

7. The printing apparatus according to claim 1, wherein
the conveyance path includes a first conveyance path, a second conveyance path downstream of the first conveyance path, and a third conveyance path downstream of the second conveyance path,
the printing unit is disposed at a position along the second conveyance path,
the flipping path is a path coupled from the third conveyance path to the first conveyance path or the second conveyance path, and
the conveyance unit includes:
a first driver configured to convey the medium along the first conveyance path,
a second driver configured to convey the medium along the second conveyance path, and
a third driver configured to convey the medium along the third conveyance path and the flipping path.
